(19) United States
(12) Patent Application Publication
(10) Pub. No.: US 2004/0228844 A1
(43) Pub. Date: Nov. 18, 2004

(54) Method for controlling harmful plant-parasitic nematodes

(76) Inventor: Shinji Isayama, Takarazuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/840,354

(22) Filed: May 7, 2004

(30) Foreign Application Priority Data
May 12, 2003 (JP) 2003-132665

(51) Int. Cl. A01N 63/00; A01N 43/20; A01N 43/24

(52) U.S. Cl. 424/93.4; 514/561

(57) ABSTRACT

A method for controlling harmful plant-parasitic nematodes characterized by applying to crops to be protected, harmful plant-parasitic nematodes or a habitat of harmful plant-parasitic nematodes an effective amount of (a) an amino acid and (b) a culture having nematocidal activity, which is obtained by cultivating the fungus, Myrothecium verrucaria, or an equivalent of said culture; and a composition to be used for such a method.

### FIELD OF THE INVENTION

The present invention relates to a method for controlling harmful plant-parasitic nematodes, and the like.

### BACKGROUND OF THE INVENTION

“Harmful plant-parasitic nematodes” used herein refer to nematodes whose nutrition for growth is dependent on higher plants and these nematodes are parasitic on crops, garden products and the like, which are important for human life. Their parasitic range is very wide and over almost all higher plants, thereby causing serious damage to agriculture in all over the world.

At present, for removing or suppressing damage caused by harmful plant-parasitic nematodes in theagricultural field, in general, controlling methods using agrochemicals such as chloropicrin, methyl bromide, methyl isothiocyanate, dazomet, aldicarb, oxamyl, fosthiazate, fenamifos, or the like, are mainly employed. However, these agrochemicals alone cannot always control nematodes sufficiently in some cases. Accordingly, it is desired to develop a method that can supplement agrochemicals in nematode control, or another alternative and effective method.

As a candidate technique for meet such a need, amino acids such as methionine and the like are known to suppress the damage of crops due to harmful plant-parasitic nematodes [e.g., Nematologica, Vol. 17, pp. 495-500 (1971); Shokubutsu Boeki (Plant Disease Prevention), Vol. 56 No. 5 pp. 22-25 (2001)].

On the other hand, as another candidate technique, a culture having nematocidal activity, which is obtained by cultivating the fungus, Myrothecium verrucaria strain ATCC 46474, is known to exhibit control effect of harmful plant-parasitic nematodes (e.g., U.S. Pat. No. 5,051,255).

However, use of only amino acids such as-methionine and the like, or use of only the above-described culture cannot always be said to exhibit sufficient control effect of harmful plant-parasitic nematodes in some cases.

### SUMMARY OF THE INVENTION

The present inventor has found that use of both of an amino acid and a culture having nematocidal activity, which is obtained by cultivating Myrothecium verrucaria, or an equivalent of the culture, is an extremely effective means for controlling harmful plant-parasitic nematodes.

That is, the present invention provides:

1. A method for controlling harmful plant-parasitic nematodes, which comprises applying to crops to be protected, harmful plant-parasitic nematodes, or a habitat of harmful plant-parasitic nematodes, an effective amount of (a) an amino acid and (b) a culture having nematocidal activity, which is obtained by cultivating Myrothecium verrucaria, or an equivalent of the culture (hereinafter., sometimes, referred to as the method of the present invention);

2. A method for controlling harmful plant-parasitic nematodes, which comprises applying to crops to be protected, harmful plant-parasitic nematodes, or a habitat of harmful plant-parasitic nematodes, a synergistic effective amount of (a) an amino acid and (b) a culture having nematocidal activity, which is obtained by cultivating Myrothecium verrucaria, or an equivalent of the culture;

3. The method according to the above 1 or 2, wherein the amino acid is methionine;

4. The method according to the above 1 or 2, wherein the amino acid is applied in an amount of about 0.05. kg to about 50 kg per 1000 m²;

5. The method according to the above 1 or 2, wherein Myrothecium verrucaria is Myrothecium verrucaria strain ATCC 46474;

6. A composition for controlling harmful plant-parasitic nematodes, which comprises (a) an amino acid and (b) a culture having nematocidal activity, which is obtained by cultivating Myrothecium verrucaria, or an equivalent of the culture (hereinafter, sometimes, referred to as the controlling composition of the present invention);

7. A composition for controlling harmful plant-parasitic nematodes, which comprises a synergistic effective amount of (a) an amino acid and (b) a culture having nematocidal activity, which is obtained by cultivating Myrothecium verrucaria, or an equivalent of the culture;

8. The composition according to the above 7 or 8, wherein the amino acid is methionine;

9. The composition according to the above 7 or 8, wherein Myrothecium verrucaria is Myrothecium verrucaria strain ATCC 46474;

10. Use of a combination of (a) an amino acidand (b) a culture having nematocidal activity, which is obtained by cultivating Myrothecium verrucaria, or an equivalent of the culture, for controlling harmful plant-parasitic nematodes;

11. Use of a combination of a synergistic effective amount of (a) an amino acid and (b) a culture having nematocidal activity, which is obtained bycultivating Myrothecium verrucaria, or an equivalent of the culture, for controlling harmful plant-parasitic nematodes;

12. The use according to the above 10 or 11, wherein the amino acid is methionine, alanine, leucine, phenylalanine, valine, aspartic acid, aminobutyric acid, ethionine, or a mixture of all or a part thereof;

13. The use according to the above 10 or 11, wherein the amino acid is methionine; and the like.

### DESCRIPTION OF THE INVENTION

In the present invention, examples of the amino acid to be used as an: active ingredient for controlling harmful plant-parasitic nematodes include naturally occurring amino acids such as methionine, alanine, leucine, phenylalanine, valine, aspartic acid, and aminobutyric acid, artificial amino acids such as ethionine, and a mixture of all or a part of these amino acids, preferably, methionine, phenylalanine, or valine.

In the present invention, examples of the “culture having nematocidal activity, which is obtained by cultivating Myrothecium verrucaria” include a culture having nematocidal activity obtained by cultivation of Myrothecium verrucaria under the conditions described hereinafter (e.g., a whole culture medium after cultivation which contains mycelia), and the like. Further, examples of the “equivalent of a culture having nematocidal activity, which is obtained by cultivating Myrothecium verrucaria” include a sterilized product of the above culture; or an extract, a partially purified product, or a purified product of the sterilized product; or an extract, a partially purified product, or a purified product of the above culture or a sterilized product thereof, which has nematocidal activity. As a solvent to be used for the extraction, for example, there are acetone, methanol, or the like. The partial purification or purification can be carried out by appropriately combining conventional fractionation and purification methods including centrifugation, filtration, extraction, or the like. Examples of the sterilization method include conventional methods such as heat sterilization, sterilization by filtration, sterilization with alcohol, gas sterilization, or the like, preferably, heat sterilization.

Typical examples of the above “culture having nematocidal activity, which is obtained by cultivating Myrothecium verrucaria, or an equivalent of the culture” (hereinafter, sometimes, generally referred to as the present culture) include the present culture obtained by cultivating Myrothecium verrucaria strain ATCC 46474 (see U.S. Pat. No. 5,051,255), or the like.

The “Myrothecium verrucaria” used herein is, for example, a fungus having the following characteristics:

(1) belonging to Hyphomycetes and not forming pycnidia and acervuli;

(2) colorless and vitreous conidiophore having septa;

(3) spindle conidia, unit cell, dark olive to dark green, 2.0 μm to 3.0 μm×7.0 μm to 8.0 μm;

(4) capable of growing on a potato-glucose medium at a temperature of 8° C. to 40° C., optimal temperature being about 25° C.; and

(5) colorless mycelia having thin septa, about 1.5 μm×about 3.0 μm.

Typical examples of Myrothecium verrucaria include Myrothecium verrucaria strain ATCC 46474. This strain has been deposited in the permanent culture collection of the American Type Culture Collection (Parklawn Drive 12301,. Rockville, Md. USA) under the accession number of ATCC 46474.

The present culture to be used can be obtained or prepared, for example, by the following method.

A fungal isolate of Myrothecium verrucaria, such as strain ATCC 46474, is cultivated in a nutrient medium to obtain the present culture.

The cultivation may be started from spores or specially grown inocula of the strain. For example, spores produced on an initial growth medium, such as potato dextrose agar, are transferred into a growth medium contained in a flask (termed seed flask) and cultivated with shaking, that would allow for the germination and initial growth of the culture. The optimal spore concentration to be used for the inoculum is easily determined by those skilled in the art by routine experimentation. The germinated spores in an active growth state may be then-transferred as an inoculum to a fermentor containing a nutrient medium. A 1-2% inoculum is typically produced for the cultivation to obtain the present culture.

The term “fermentor”, as used herein refers to apparatus used for various types of fermentation methods including, but not limited to, shaken culture, solid-state, continuous and batch fed methods that are contemplated for production of the present culture in both laboratory and large scale fermentation processes. The cultivation can be carried out in shake-flasks or in stationary-vat fermentors. In shake-flasks, aeration is provided by agitation of the flask which causes mixing of the medium with air. A wide range of shaker-culture apparatus may be used to agitate the flask. The main types of are based on either rotary or reciprocating shaking machines. The process herein preferably uses rotary shakers in which the flasks move in orbits of about 50 mm at about 200 to about 250 rpm, (but may vary between 100 and 500 rpm). The culture moves smoothly around the inside of the flask which is usually an Erlenmeyer flask. In the stationary fermentors, agitation is provided by impeller means such as a disc turbine, vaned disc, open turbine, or marine propeller; and aeration is accomplished by injecting air or oxygen into, the cultivation mixture.

The nutrient medium consists of suitable sources of carbon, nitrogen, inorganic salts, and growth factors assimilable by the microorganism. Suitable examples of carbon sources are various sugars such as dextrose, glucose, lactose, and maltose, starch, dextrin, corn mealand glycerol.

The sources of nitrogen can be of organic, inorganic or mixed organic-inorganic origin. Examples of nitrogen sources that can be used in the medium are soybean meal, corn steep liquor, peanut meal, cottonseed meal, corn germ meal, and various ammonium salts.

The inclusion of certain amounts of minerals and growth factors in the medium is also helpful. Crude medium ingredients such as distillers' solubles, corn steep liquor, fish meal, yeast products, peptonized milk and whey contain not only minerals but growth factors. Inorganic salts such as potassium phosphate, sodium chloride, ferric sulfate, calcium carbonate, cobalt chloride, magnesium sulfate, and zinc sulfate can be added to the medium.

Solid materials, such as calcium carbonate are preferably added in this process, to help with pH control of cultures.

The time for cultivation to obtain the present culture is preferably, from about 4 days to about 7 days, most preferably about 5 days. The temperature of the medium is from about 20° C. to about 40° C. Preferably the temperature is from about-25° C. to about 30° C. and most preferably about 25° C. The pH of the medium is from about 4 to about 10, preferably from about 5 to about 8, and most preferably at neutral pH. The recovery of the present culture may be carried out by techniques well known in the art.

Further, the present culture as an equivalent can be prepared by extracting a component having nematocidal activity from the present culture thus prepared with a suitable solvent such as acetone. Furthermore, the present culture in the form of a powder can be obtained by lyophilizing the present culture and then reducing it to powder. Moreover, the present culture is commercially available and such a culture can also be used. For example, DiTera (trade-name; manufactured by Valent Bibsciences Corporation) or the like is known as a commercially available product as the present culture, but not limited thereto.

Examples of the harmful plant-parasitic nematodes to be controlled by the present invention include:

Nematodes of the genus Meloidogyne such as Meloidogyne incognita, Meloidogyne javanica, Meloidogyne hapla, Meloidogyne arenaria, and the like; nematodes of the genus Ditylelenchus such as Ditylelenchus destructor, Ditylelenchus dipsaci, and the like; nematodes of the genus Pratylenchus such as Pratylenchus penetrans, Pratylenchus fallax, Pratylenchus coffeae, Pratylenchus vulnus, and the like; nematodes of the genus Globodera such as Globodera rostochiensis, Globodera pallida, and the like; nematodes of the genus Heterodera such as Heterodera glycines, Heterodera shachtoii and the like; nematodes of the genus Aphelenchus such as Aphelenchus avenae, and the like; and nematodes of the genus Radopholus such as Radopholus similis and the like. However, the harmful plant-parasitic nematodes are not limited thereto.

The method of the present invention can be used to control nematodes for a variety of agricultural applications on many different plants and fruits including, but not limited to, tomatoes, artichokes, aubergines, banana, barley, beetroots, cacao, carrots, cassaya, celery, chickpea, citrus, coconut, coffee, corn, cotton, cowpea, eggplant, field bean, forages, grape, guava, melons, millet; oat, okra, ornamentals, papaya, peanut, pepper, pigeon pea, pineapple, potatoes, rice, rye, sorghum, soybean, sugar beet, sugar cane, sweet peppers, sweet potato, tea, tobacco, various lettuces, wheat and yam. Cultivated flowers can be protected according to the present invention, such as carnations, rose bushes, gerberas and chrysanthemums, pot plants, philodendrons, figs, pothos, sansevierias, and cacti; examples of nursery plants would include all the ornamental and flowering shrubs.

The present invention is characterized by using combination of an amino acid and a culture having nematocidal activity, which is obtained by cultivating Myrothecium verrucaria, or an equivalent of the culture (i.e., the present culture). The mixing ratio or combination ratio thereof is, for example, that bringing about synergistic effect of nematocidal activity and may be, specifically, from about 10 g to about 200 kg of an amino acid, preferably from about 20 g to about 4 kg relative to 100 g of the present culture.

In the method of the present invention, (a) an amino acid and (b) a culture having nematocidal activity, which is obtained by cultivating Myrothecium verrucaria, or an equivalent of the culture may be applied simultaneously. Alternatively, separate preparations containing an amino acid, and a culture having nematocidal activity, which is obtained by cultivating Myrothecium verrucaria, or an equivalent of the culture, respectively have been prepared in advance and they may be applied.

The controlling composition of the present invention may be a mixture of (a) an amino acid and (b) a culture having nematocidal activity, which is obtained by cultivating, Myrothecium verrucaria, or an equivalent of the culture (i.e., the present culture) as such. However, the controlling composition is normally admixed further with a solid carrier or a liquid carrier and, if necessary, a surfactant, other formulation auxiliaries and the like are added thereto to obtain a preparation in the form of an oil solution, an emulsion, a wettable powder, wettable granules, a flowable agent (dispersible agent in water, emulsifiable agent in water, or the like), a powder, particles, microcapsules, and the like.

Usually, the preparation contains both of an amino acid and the present culture in a total amount of about 0.01% by weight to about 99% by weight, preferably about 5% by weight to about-95% by weight. The mixing ratio of an amino-acid and the present culture is, for example, that bringing about synergistic effect of nematocidal-activity and may be, specifically, about 1 to about 20000 parts by weight, preferably about 2 to 400 parts by weight of an amino acid relative to 10 parts by weight of the present culture.

Examples of the solid carrier to be used for preparing the preparation include fine powders and granules such as clay (kaoline clay, diatomaceous earth, bentonite, Fubasami Clay, acidic white clay, and the like), synthetic hydrated silicon oxide, talc, ceramic, other inorganic minerals (sericite, quartz, sulfur, activated carbon, calcium carbonate, hydrated silica, and the like), fertilizers (ammonium sulfate, ammonium phosphate, ammonium nitrate, urea, ammonium chloride, and the like), or the like.

Examples of the liquid carrier include water, alcohols (methanol, ethanol, and the like), ketones (acetone, methyl ethyl ketone, and the like), aromatic hydrocarbons (toluene, xylene, ethylbenzene, methylnaphthalene, and the like), aliphatic hydrocarbons (hexane, cyclohexane, kerosene, light oil, and the like), esters (ethyl acetate, butyl acetate, and the like), nitrites (acetonitrile, isobutyronitrile, and the like), ethers (diisopropyl ether, 1,4-dioxane- and the like), acid amides (N,N-dimethylformamide, N,N-dimethylacetamide, and the like), halogenated hydrocarbons (dichloromethane, trichloroethane, carbon tetrachloride, and the like), dimethyl sulfoxide, vegetable oils (soy oil, cotton oil, and the like), and the like.

Examples of the surfactant include alkyl sulfates, alkyl sulfonate salts, alkylaryl sulfonate salts, alkylaryl ethers and its polyoxyethylenated derivatives, polyethylene glycol ethers, polyalcohol esters, sugar alcohol derivatives, and the like.

Examples of the other formulation auxiliaries include adhesive agents, dispersing agents, stabilizers, and the like. More specifically, examples of the formulation auxiliaries-include casein, gelatin, polysaccharides (starch, gum arabic, cellulose derivatives, alginic acid, and the like), lignin derivatives, bentonite, saccharides, synthetic water-soluble polymers (polyvinyl alcohol, polyvinyl pyrolidone, polyacrylic acids, and the like), PAP (acidic isopropyl phosphate), BHT (2,6-di-tert-butyl-4-methylphenol), BHA (a mixture of 2-tert-butyl-4-methoxyphenol and 3-tert-butyl-4-methoxyphenol). mineral oils, fatty acids, fatty acid esters, and the like.

The controlling composition of the present invention may be produced by mixing a preparation of an amino acid which has been prepared in advance, and a preparation of the present culture which has been prepared in advance, depending on a particular preparation form. Further, both of the preparations can also be mixed or used together upon application.

In the present invention, for example, effective or application amounts of the active ingredients for controlling harmful plant-parasitic nematodes are usually from about 0.05 kg to about 50 kg per 1000 m² in terms of an effective or application amount of an amino acid. In addition, when the active ingredients for controlling harmful plant-parasitic nematodes are directly applied as such by means of granules, a powder, and the like, they may be applied so that the aforementioned effective or application amounts are achieved. Further, when the active ingredients for controlling harmful plant-parasitic nematodes are applied by diluting an emulsion, a wettable powder, wettable granules, a flowable agent, or the like, they may be diluted with water so that the aforementioned effective or application amounts are achieved.

In the present invention, harmful plant-parasitic nematodes can be controlled, for example, by applying the composition of the present invention to crops to be protected, harmful plant-parasitic nematodes, or a habitat of harmful plant-parasitic nematodes (e.g., soil where nematodes are expected to have inhabited or invaded).

Any of the above-mentioned effective or application amounts vary depending upon the kinds of preparations, the time of application, the place of application, the method of application, the types of pest, and the conditions such as the extent of damage, and thus the above-mentioned amounts can be appropriately selected by increasing or decreasing, as required, regardless of the above-mentioned ranges.

### EXAMPLES

Hereinafter, the present invention will be illustrated in more detail by means of Reference Example, Formulation Examples and Test Examples, but the present invention is by no means limited to these Examples. In the Preparation Examples, all parts are by weight.

### Reference Example

Myrothecium verrucaria strain ATCC 46474 is inoculated on a sterilized potato-dextrose liquid culture medium. This is cultivated at 25° C. for about 3 to about 4 weeks to prepare a seed culture. The seed culture-(0.1 mL) thus prepared is inoculated on a sterilized liquid culture medium (100 mL; composition of the culture medium: 2 g of glucose, 15 g of soluble starch, 2 g of a yeast extract, 0.3 g of magnesium sulfate hydrate, 1 g of calcium carbonate, 5 g of neopeptone, and 1000 mL of distilled water; pH 7.0). This is cultivated with shaking at 25° C. for 5 days. After cultivation, the culture thus obtained is autoclaved (120° C., 1.2 atmospheric pressure for 20 minutes) to prepare the present culture.

### Formulation Example 1

Both of 15 parts of methionine and 5 parts of a preparation obtained by heat-sterilizing a culture of Myrothecium verrucaria strain ATCC 46474 prepared according to the same manner as that described in Reference Example are mixed with 20 parts of cotton oil and 20 parts of N,N-dimethylformamide with stirring. To this are added 10 parts of polyethylene glycol and 10 parts of calcium dodecylbenzenesulfonate and the resulting mixture is thoroughly stirred and suspended to obtain an emulsion.

### Formulation Example 2

Both of 60 parts of methionine and 10 parts of a preparation obtained by heat-sterilizing a culture of Myrothecium verrucaria strain ATCC 46474 prepared according to the same manner as that described in the above Reference Example are added to a mixture of 4 parts of sodium lauryl sulfate, 2 parts of calcium lignin sulfonate, 12 parts of a synthetic hydrated silicon oxide powder and 12 parts of diatomaceous earth. The resultant mixture is thoroughly stirred to obtain a wettable powder.

### Formulation Example 3

A mixture of 15 Parts of methionine, 5 parts of a preparation obtained by heat-sterilizing a culture of Myrothecium verrucaria strain ATCC 46474 prepared according to the same manner as that described in the above Reference Example, 5 parts of a synthetic hydrated silicon oxide powder, 5 parts of sodium dodecylbenzenesulfonate, 30 parts of bentonite and 40 parts of clay is thoroughly stirred. Then, to the mixture is added an appropriate amount of water, and the resultant mixture is further stirred, granulated by a granulator, and air-dried to obtain granules.

### Test Example 1

Both of methionine (manufactured by Sumitomo Chemical Co., Ltd., hereafter, sometimes, referred to as component A agent) and the commercially available present culture (wettable granular preparation containing 90% by weight of a preparation obtained by sterilizing a culture obtained by cultivating Myrothecium verrucaria strain ATCC 46474, trade name: DiTera DF manufactured by Valent Biosciences. Corporation, hereafter, sometimes, referred to as component B agent) were diluted with 100 mL of water at given concentrations, respectively, to prepare respective test solutions.

To 5 kg of nematode-infested soil (nematode density: 2255 nematodes per 20 g (investigation method: Bellman's method)) in which Meloidogyne incognita seriously grew was applied each (100 mL) of the test solutions diluted at given concentrations: and then the resulting soil was thoroughly mixed. In a plastic cup (860 mL, diameter: about 10 cm, height: about 11 cm) having three small holes. (diameter: about 3 mm), 500 g of each of the soil to which each test solution was applied and mixed was placed. Cucumber seedlings (14 days after sowing, 2 plants per cup, 5 replications) were transplanted in the cup, which contained each treated soil. After transplantation, the plants were left in a glass greenhouse.

At 50 days after the transplantation, the roots of plants were washed with water and then degrees of root-knot damages of the roots were observed to calculate the average degree of root-knot damages per 10 plants. The degree of root-knot damages was evaluated according to the following criteria:

5: The plant is withered and dead due to parasitism of nematodes.

4: A number of root-knots, which range to form-large root-knots, are observed on the entire roots.

3: Root-knots are observed on the entire roots, and large root-knots being partly formed.

2: Formation of root-knots is partly observed on the root, and some of them ranging, but no large root-knot is observed.

1: A little formation of root-knots is observed.

0: No formation of root-knots is found.

The results are shown in the Table 1.

TABLE 1

| | | Average Degree | |
|---|---|---|---|
| | Amount of | of Root-Knots | |
| | Treatment | Damages | |
| Test Group | (for 1000 m²) | (Standard error) | Remarks |
| Component A | 20 kg | 3.2 | Comparative |
| Agent | | (±0.33) | Example |
| Component B | 20 kg | 4.0 | Comparative |
| Agent | | (±0.30) | Example |
| Use of | 17.5 kg | 2.3 | The Present |
| Combination of | (component A | (±0.50) | Invention |
| both Component | agent) + 2.5 | | |
| A Agent and | kg (component | | |
| Component B | B agent) | | |
| Agent | | | |
| Non-treatment | — | 4.7 | Control |
| | | (±0.15) | |

As shown in Table 1, when component A agent and component B agent were applied in combination (invention group), a synergistic effect of control of root-knot damages was recognized in comparison with application of component A agent or component B agent alone (comparative groups).

### Test Example 2

Respective test solutions were prepared by diluting component A agent and component B agent with water 100 mL. at given concentrations, respectively.

To 3 kg of the Meloidogyne incognita-infested soil was applied each (100 mL) of the test solutions diluted at given concentrations and then the resulting soil was thoroughly mixed. In a plastic cup (860 mL, diameter: about 10 cm, height: about 11 cm) having three small holes (diameter: 3 mm), 500 g of each of the soil to which each test solution was applied and mixed was placed. Cucumber seedlings (14 days after sowing, 2 plants per cup, 6 replications) were transplanted in the cup, which contained each treated soil. After transplantation, the plants were left in a glass greenhouse.

At 32 days after the transplantation, the roots of plants were washed with water and then the gall number on the roots per plant was observed to calculate the gall control value. The gall control value was calculated by the following equation:

Gall control value=(C−S)×100/C

wherein C is an average gall number per plant in a non-treated group, and S is an average gall number per plant in a treated group.

The results are shown in Table 2.

TABLE 2

| | | Gall | |
|---|---|---|---|
| Test | Amount of Treatment | Control | |
| Group | (/1000 m²) | Value | Remarks |
| Component | 20 kg | 44 | Comparative |
| A Agent | | | Group |
| Component | 12.5 kg | 6 | Comparative |
| B Agent | | | Group |
| Use of | 20 kg (A) + 0.5 kg (B) | 65 | Invention |
| Combination | 20 kg (A) + 1 kg (B) | 65 | Group |
| of both | 20 kg (A) + 2 kg (B) | 80 | |
| Component | 20 kg (A) + 4 kg (B) | 92 | |
| A Agent and | | | |
| Component | | | |
| B Agent | | | |
| Non- | — | 0 | Control |
| treatment | | | Group |

As described hereinabove, the present invention can provide a method that can supplement agrochemicals for controlling nematodes, or an alternative method for effectively controlling nematodes.

1. A method for controlling harmful plant-parasitic nematodes, which comprises applying to crops to be protected, harmful plant-parasitic nematodes, or a habitat of harmful plant-parasitic nematodes, an effective amount of
(a) an amino acid and
(b) a culture having nematocidal activity, which is obtained by cultivating Myrothecium verrucaria, or an equivalent of said culture.

2. A method for controlling harmful plant-parasitic nematodes, which comprises applying to crops to be protected, harmful plant-parasitic nematodes, or a habitat of harmful plant-parasitic nematodes, a synergistic effective amount of
(a) an amino acid and
(b) a culture having nematocidal activity, which is obtained by cultivating Myrothecium verrucaria, or an equivalent of said culture.

3. The method according to claim 1, wherein the amino acid is methionine.

4. The method according to claim 1, wherein the amino acid is applied in an amount of about 0.05 kg to about 50 kg per 1000 m².

5. The method according to claim 11, wherein Myrothecium verrucaria is Myrothecium verrucaria strain ATCC 46474.

6. A composition for controlling harmful plant-parasitic nematodes, which comprises (a) an amino acid and (b) a culture having nematocidal activity, which is obtained by cultivating Myrothecium verrucaria, or an equivalent of said culture.

7. A composition for controlling harmful plant-parasitic nematodes, which comprises a synergistic effective amount of (a) an amino acid and (b) a culture having nematocidal activity, which is obtained by cultivating Myrothecium verrucaria, or an equivalent of said culture.

8. The composition according to claim 6, wherein the amino acid is methionine.

9. The composition according to claims 6, wherein Myrothecium verrucaria is Myrothecium verrucaria strain ATCC 46474.

10. Use of a combination of (a) an amino acid and (b) a culture having nematocidal activity, which is obtained by cultivating Myrothecium verrucaria, or an equivalent of said culture, for controlling harmful plant-parasitic nematodes.

11. Use of a combination of a synergistic effective amount of (a) an amino acid and (b) a culture having nematocidal activity, which is obtained by cultivating Myrothecium verrucaria, or an equivalent of said culture, for controlling harmful plant-parasitic nematodes.

12. The use according to claim 10, wherein the amino acid is methionine, alanine, leucine, phenylalanine, valine, aspartic acid, aminobutyric acid, ethionine, or a mixture of all or a part thereof.

13. The use according to claim 10, wherein the amino acid is methionine.

14. The method according to claim 2, wherein the amino acid is methionine.

15. The method according to claim 2, wherein the amino acid is applied in an amount of about 0.05 kg to about 50 kg per 1000 m².

16. The method according to claim 2, wherein Myrothecium verrucaria is Myrothecium verrucaria strain ATCC 46474.

17. The composition according to claim 7, wherein the amino acid is methionine.

18. The composition according to claim 7, wherein Myrothecium verrucaria is Myrothecium verrucaria strain ATCC 46474.

19. The use according to claim 11, wherein the amino acid is methionine, alanine, leucine, phenylalanine, valine, aspartic acid, aminobutyric acid, ethionine, or a mixture of all or a part thereof.

20. The use according to claim 11, wherein the amino acid is methionine.
